(19) United States
(12) Patent Application Publication
(10) Pub. No.: US 2005/0161936 A1
(43) Pub. Date: Jul. 28, 2005

(54) Adventure photography method and apparatus

(76) Inventors: Robert Sesek, Meridian, ID (US); Curtis Reese, Boise, ID (US); Daniel Travis Lay, Horseshoe Bend, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/762,853

(22) Filed: Jan. 22, 2004

(51) Int. Cl. B42D 1/00; B42D 5/00

(52) U.S. Cl. 281/38

(57) ABSTRACT

A photography guidebook and method of using the same provides technical details for replication of photographs taken previously. The guidebook may contain information about numerous aspects of a photograph, and captions and blank photograph locations for mounting the photographs taken to replicate the previously taken photographs.

### FIELD

The present invention relates generally to photography, and, in particular, the present invention relates to reproduction of pictures using a guide.

### BACKGROUND

Cameras and especially digital cameras have become commonplace in modern society. The technology of capturing digital images has advanced rapidly. Traditional non-digital cameras (such as, but not limited to, reflex cameras, instant cameras, video cameras, and the like) already are capable of recording information about images including, for example, the time and date of image capture.

Cameras that record the location of the object of an image, as well as the methods for recording the location of the object of an image, are disclosed in detail in co-pending, commonly owned U.S. Patent Application, entitled IMAGE DATA CAPTURE METHOD AND APPARATUS, filed on Aug. 28, 2003, and assigned Ser. No. 10/650,219. The disclosure thereof is incorporated by reference herein in its entirety.

Many books containing photographs of scenic views such as natural wonders, man-made wonders, and the like are available for sale. The images are often memorable. However, the amount of time and effort required to obtain such photographs often is beyond the skill and patience level of amateur photographers and tourists. Nevertheless, personalized photographs, such as those including specific persons and the like, are many times triggers for memories of a vacation or experience. For that reason, many tourists and vacationers enjoy taking photographs during a trip.

Since many people take pictures while they are traveling, there are also many remarkable images that are taken by non-professional photographers. Many people who will be traveling to a particular location, having seen pictures taken there by friends or relatives, desire to find the location of the picture taking, and may desire to attempt to reproduce the image. However, once again, time and skill constraints make such an endeavor difficult or even impossible.

For the reasons stated above, and for other reasons stated below which will become apparent to those skilled in the art upon reading and understanding the present specification, there is a need in the art for an improved position recording system as well as for a system that more clearly identifies the position of a camera or image upon taking a picture with the camera.

### SUMMARY

The above-mentioned problems of finding a good photography location and replication of images, and other problems, are addressed by the present invention and will be understood by reading and studying the following specification.

In one embodiment, a guidebook for taking photographs includes a number of blank photograph locations, and a number of photograph descriptions of the blank photograph locations.

In another embodiment, a system includes a camera and a guidebook. The guidebook includes a number of blank photograph locations and photograph descriptions of the blank photograph locations.

In yet another embodiment, a method of photographing a subject includes retrieving photograph details in a guidebook, navigating to a photograph taking location, orienting a camera according to the retrieved photograph details, and photographing a subject once the camera is oriented.

In still another embodiment, a method of reproducing a base photograph includes retrieving from a guidebook base photograph details for a particular photograph to be taken, replicating the technical details, and reproducing the base photograph after replicating the technical details.

Other embodiments are described and claimed.

### BRIEF DESCRIPTION OF DRAWINGS

FIG. 1 is a block diagram of a photography system, according to one embodiment of the present invention;

FIG. 2 is a block diagram of a guidebook, according to another embodiment of the present invention; and

FIG. 3 is a flow chart diagram of a photography method, according to another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

The following detailed description is, therefore, not to be taken in a limiting sense, and the scope of the present invention is defined only by the appended claims, along with the full scope of equivalents to which such claims are entitled.

When a photographer uses a camera that records the location of the object of the image, along with the location of the camera and other details such as inclination of the camera, magnetic bearing of the camera lens (that is the angle of the lens with respect to north), that information allows the photograph, that has been taken, to be potentially reproduced by going to the location, and arranging the camera in such a manner as to duplicate the position, inclination, and facing of the camera.

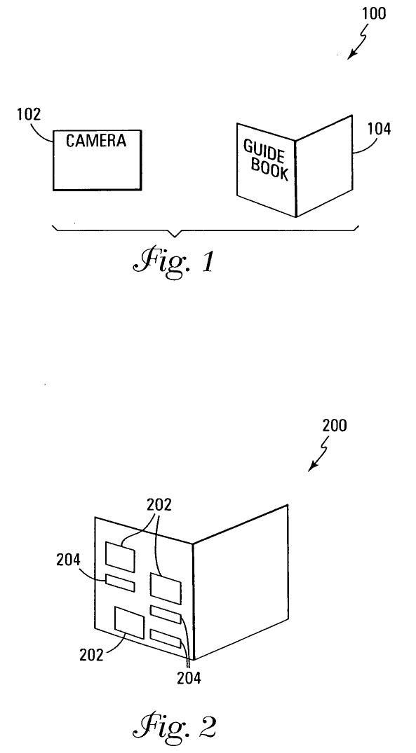

FIG. 1 shows a system 100 for providing an adventure or photography book. The system 100 comprises a camera 102 and a handbook or workbook 104. The camera is of a type described in co-pending, application Ser. No. 10/650,219, that has the capability for determining the location of the object of an image, as well as the location, orientation, and inclination of the camera itself. A user of the system 100 uses the guidebook 104 as a guide for a tour of, for example, a location such as a national park or the like. The guidebook 104 is a guide to a series of pictures that are to be taken or “filled in” by the user of the guidebook. A guidebook such as guidebook 104 will be described in greater detail below.

In operation, the system 100 functions as follows. The guidebook is used to contain information about a series of pictures taken at a series of locations, for example in a national park. The information about the pictures includes location information for the camera that took each picture, and the orientation details of the camera, that is the magnetic bearing of the camera lens, the inclination, and the location of the object of the image. A user of the guidebook obtains the book, and using a camera of the type described, or using a one or more of a global positioning system, a compass, an inclinometer, and a range finder in addition to a standard camera, proceeds to find the location of the photograph that fits the blank in the guidebook. Once at the location, the user can, using the camera or the tools described, re-create the photograph that is suggested in the guidebook. This eliminates the need for a guided tour of a location if the user wishes to take a self guided tour of the type described. The guidebook in one embodiment is in the form of a scrapbook that accommodates pictures once they are developed. The description of the picture and any pertinent information about the subject of the picture are present without the need for the photographer to recall any information about the object of the photograph.

FIG. 2 is a perspective view of a guidebook 200 according to one embodiment of the present invention. Guidebook 200 comprises a plurality of blank photograph locations 202, each photograph location 202 having its own description 204 of the picture that corresponds to the location 202. Each description 204 includes one or more of the following: camera location when the picture was taken, coordinates for the object of the image of the photograph, magnetic bearing of the lens of the camera, inclination of the camera, shutter speed, aperture, film type, and environmental conditions, including, but not limited to, temperature, relative humidity, and lighting conditions. It should be understood that any data a camera such as camera 102 of system 100 can record may, in various embodiments, be included in the description 204. In one embodiment, descriptions 204 are placed in a portion of the guidebook 200 separate from the photograph locations 202, so that the locations 202 are not cluttered with a detailed description of the specifics of reproducing a photograph.

In various embodiments, guidebooks such as those described herein are created using digital picture information gathered from cameras such as those described in co-pending application. In this manner, self-guided tours can be accomplished using common navigational tools, the guidebook, and a suitable camera.

In still another embodiment, the guidebooks are used as contest blanks, where the object of a contest or the like is to navigate to a given location, orient a picture, and try to most closely replicate a base picture or series of base pictures of various objects, in a timed exercise or the like. A guidebook and camera may be supplied, and the contest is to see which team or individual can most closely replicate known photographs in a timed event.

In a more leisurely application of the embodiments of the present invention, there are many vacationers and tourists who wish to take their own photographs, but who lack the skill or time necessary to choose good camera shots. Using guidebooks and cameras such as those described herein, a tourist can navigate to a provided location to arrive at a spot of known selected criteria for a photograph opportunity. There are many tourists who use guided tours at considerable expense in order to get to desirable photography locations. In contrast, the guidebooks of the present invention provide a lower cost, less structured and more leisurely opportunity to use the skills of a professional photographer in picture composition to replicate photographs.

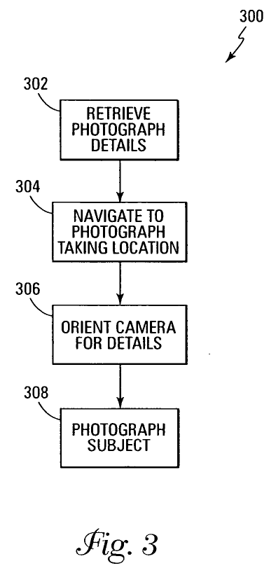

A method embodiment of the present invention comprises using the guidebook for instructions on getting to a photo taking location, then orienting a camera the way it is desired or shown or indicated in the guidebook, then taking a photograph. A series of guidebooks could be generated for any number of situations, such as nature photography, architectural photography, and the like. With reference to FIG. 3, method 300 comprises in one embodiment finding photograph details in a guidebook in block 302, navigating to the photograph taking location in block 304, orienting a camera properly in block 306, and photographing a subject in block 308.

By using the embodiments of the present invention, amateur photographers can attempt to replicate known pictures in a leisurely manner. Further, the guidebooks of the present invention serve among other purposes that of cataloguing what the pictures taken on a vacation or the like are without the need to remember or notate details about each picture when it is taken. The user can enjoy the views and ambience of a photography trip without the worries of having to carry around note paper or having to remember exactly what pictures were taken.

### CONCLUSION

Photography and adventure guidebooks and methods for using the guidebooks and for taking photographs have been described that include descriptions of known locations and photograph subjects that can be taken from the locations.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A photography guidebook, comprising
a plurality of blank photograph locations; and
a plurality of photograph descriptions of the blank photograph locations.

2. The photography guidebook of claim 1, wherein each of the plurality of descriptions comprises one or more of:
a camera location when the picture was taken;
coordinates for the object of the image of the photograph;
a magnetic bearing of the lens of the camera;
an inclination of the camera;
a shutter speed of the camera;
an aperture of the camera;
a plurality of environmental conditions; and
a film type for the camera.

3. The photography guidebook of claim 1, wherein the descriptions are placed in a portion of the guidebook separate from the photograph locations.

4. The photography guidebook of claim 1, wherein the descriptions are placed adjacent their respective photograph locations.

5. The photography guidebook of claim 1, wherein the descriptions comprises a caption for the photograph and a set of technical details of the photograph location.

6. The photography guidebook of claim 5, wherein the technical details are placed in a portion of the guidebook separate from the photograph locations and the captions.

7. An adventure workbook, comprising:
a plurality of blank photograph locations; and
a plurality of photograph descriptions for the blank photograph locations, each photograph description containing technical details of a photograph corresponding to the blank photograph location.

8. The adventure workbook of claim 7, wherein the technical details comprise:
a camera location when the picture was taken;
coordinates for the object of the image of the photograph;
a magnetic bearing of the lens of the camera;
an inclination of the camera;
a shutter speed of the camera;
an aperture of the camera;
a plurality of environmental conditions; and
a film type for the camera.

9. The adventure workbook of claim 7, wherein the technical details are placed in a portion of the guidebook separate from the photograph locations and the captions.

10. A system, comprising:
a camera; and
a guidebook, the guidebook comprising:
a plurality of blank photograph locations; and
a plurality of photograph descriptions of the blank photograph locations.

11. The system of claim 10, wherein each of the plurality of descriptions comprises one or more of:
a camera location when the picture was taken;
coordinates for the object of the image of the photograph;
a magnetic bearing of the lens of the camera;
an inclination of the camera;
a shutter speed of the camera;
an aperture of the camera;
a plurality of environmental conditions; and
a film type for the camera.

12. The system of claim 10, wherein the descriptions are placed in a portion of the guidebook separate from the photograph locations.

13. The system of claim 10, wherein the descriptions are placed adjacent their respective photograph locations.

14. A method of photographing a subject, comprising:
retrieving photograph details in a guidebook;
navigating to a photograph taking location;
orienting a camera according to the retrieved photograph details; and
photographing a subject once the camera is oriented.

15. The method of claim 14, wherein the photograph details comprise at least one of a camera location when the picture was taken, coordinates for the object of the image of the photograph, a magnetic bearing of the lens of the camera, an inclination of the camera, a shutter speed of the camera, an aperture of the camera, a plurality of environmental conditions, and a film type for the camera.

16. The method of claim 14, and further comprising:
using a camera that allows for the reproduction of the photograph details.

17. A method of reproducing a base photograph, comprising:
retrieving from a guidebook a plurality of base photograph details for a particular photograph to be taken;
replicating the technical details; and
reproducing the base photograph after replicating the technical details.

18. The method of claim 17, wherein replicating the technical details comprises:
navigating to a location contained in the technical details; and
positioning a camera using the technical details.

19. The method of claim 18, wherein positioning the camera comprises replicating at least one of:
a camera location when the base photograph was taken, coordinates for the object of the image of the base photograph, a magnetic bearing of the lens of the camera, an inclination of the camera, a shutter speed of the camera, an aperture of the camera, a plurality of environmental conditions, and a film type for the camera.

20. A guidebook for taking photographs, comprising::
means for retrieving photograph details in a guidebook;
means for navigating to a photograph taking location;
means for orienting a camera according to the retrieved photograph details; and
means for photographing a subject once the camera is oriented.

21. The guidebook of claim 20, wherein the photograph details comprise at least one of a camera location when the picture was taken, coordinates for the object of the image of the photograph, a magnetic bearing of the lens of the camera, an inclination of the camera, a shutter speed of the camera, an aperture of the camera, a plurality of environmental conditions, and a film type for the camera.

22. The guidebook of claim 20, and further comprising:
using a camera that allows for the reproduction of the photograph details.

23. A system for reproducing a base photograph, comprising:
a guidebook having a plurality of blank photograph locations and a plurality of technical details for identifying each of the blank photograph locations; and
means for replicating the technical details.

24. The system of claim 23, wherein the means for replicating comprises:
a camera; and
wherein each of the plurality of technical details comprises one or more of:
a camera location when the picture was taken;
coordinates for the object of the image of the photograph;
a magnetic bearing of the lens of the camera;
an inclination of the camera;
a shutter speed of the camera;
an aperture of the camera;
a plurality of environmental conditions; and
a film type for the camera.
